(19) United States
(12) Patent Application Publication
(10) Pub. No.: US 2011/0058955 A1
(43) Pub. Date: Mar. 10, 2011

(54) ROTOR BLADE FOR ROTARY WING AIRCRAFT HAVING DEFORMABLE PROTRUSIONS TO REDUCE BLADE VORTEX INTERACTION NOISE

(76) Inventors: Sung Nam Jung, Seoul (KR); Yung Hoon Yu, Seoul (KR); Chang Joo Kim, Seoul (KR); Soo Hyung Park, Seoul (KR)

(21) Appl. No.: 12/945,293

(22) Filed: Nov. 12, 2010

(30) Foreign Application Priority Data
Apr. 8, 2009 (KR) 10-2009-0030496

(51) Int. Cl. F03B 3/12

(52) U.S. Cl. 416/241 R

(57) ABSTRACT

A rotor blade for a rotary wing aircraft, which rotates about and is combined with a rotation shaft of the rotary wing aircraft. The rotor blade includes a body combined with the rotation shaft and including a leading edge that is a front edge in a direction of rotation; and a plurality of deformable protrusions formed on the leading edge of the body in a radial direction of rotation, and deformable between a first shape protruding forward in the direction of rotation and a second shape not protruding forward in the direction of rotation such that BVI noise generated when a vortex formed near a blade tip collides with the rotor blade is selectively reduced whenever necessary. The deformable protrusions are formed in a region from a point spaced apart from the rotation shaft by 75% of a radius of rotation to a point spaced apart from the rotation shaft by 90% of the radius of rotation.

### FIELD OF THE INVENTION

The present invention relates to a rotor blade for a rotary wing aircraft, and more particularly, to a rotor blade for a rotary wing aircraft, capable of selectively reducing blade vortex interaction (BVI) noise whenever necessary, and reducing manufacturing and operating costs.

### BACKGROUND OF THE INVENTION

Blade vortex interaction (BVI) noise is generated when a vortex formed near a tip of a rotor blade collides with a subsequently rotating rotor blade. In particular, BVI noise is greatly generated most when a rotary wing aircraft descends slowly to land.

FIG. 1 is a plan view of a rotary wing aircraft 9 including conventional rotor blades 1a through 1d when the rotary wing aircraft 9 flies forward F and descends slowly. FIG. 2 is a magnified view of the conventional rotor blade 1a illustrated in FIG. 1.

Referring to FIGS. 1 and 2, the rotary wing aircraft 9 includes a rotation shaft H that is rotated by a drive source, and the four conventional rotor blades 1a through 1d combined with the rotation shaft H, rotating in a direction of rotation A, e.g., a counterclockwise direction, and each having a linear leading edge 2.

As illustrated in FIG. 1, when the conventional rotor blades 1a through 1d having the linear leading edges 2 rotate in the air, vortices 1a′ through 1d′ are respectively generated near tips of the conventional rotor blades 1a through 1d, and the vortices 1a′ through 1d′ bend toward insides of the conventional rotor blades 1a through 1d, i.e., toward the rotation shaft H and then recede downward in spiral shapes. However, since the rotary wing aircraft 9 is descending, the vortices 1a′ through 1d′ collide with the conventional rotor blades 1a through 1d.

In particular, as illustrated in FIG. 2, the rotor blade 1a located at a first quadrant of the tail of the rotary wing aircraft 9 collides with the vortex 1b′ generated by the previous rotor blade 1b almost in parallel. If a rotor blade and a vortex collide with each other in parallel, BVI noise is strong. That is, if an angle P1 between the vortex 1b′ and the leading edge 2 of the rotor blade 1a is small and thus the vortex 1b′ collides with the rotor blade 1a in parallel, BVI noise is strong. Otherwise, if the angle P1 is close to 90° and thus the vortex 1b′ collides with the rotor blade 1a perpendicularly, BVI noise is weak.

As described above, the conventional rotor blades 1a through 1d having the linear leading edges 2 cause strong BVI noise when the rotary wing aircraft 9 descends slowly, which provides serious displeasure to people on the ground that are near the rotary wing aircraft 9.

Also, if the conventional rotor blades 1a through 1d are used for a military rotary wing aircraft, due to strong BVI noise, the military rotary wing aircraft may be easily detected by the enemy even from a long distance.

### SUMMARY OF THE INVENTION

The present invention provides a rotor blade for a rotary wing aircraft capable of selectively reducing blade vortex interaction (BVI) noise whenever necessary, and reducing manufacturing and operating costs.

According to an aspect of the present invention, there is provided a rotor blade for a rotary wing aircraft, which rotates about and is combined with a rotation shaft of the rotary wing aircraft, the rotor blade including a body combined with the rotation shaft and comprising a leading edge that is a front edge in a direction of rotation; and a plurality of deformable protrusions formed on the leading edge of the body in a radial direction of rotation, and deformable between a first shape protruding forward in the direction of rotation and a second shape not protruding forward in the direction of rotation such that BVI noise generated when a vortex formed near a blade tip collides with the rotor blade is selectively reduced whenever necessary, wherein the deformable protrusions are formed in a region from a point spaced apart from the rotation shaft by 75% of a radius of rotation to a point spaced apart from the rotation shaft by 90% of the radius of rotation.

Here, spaces that are sealable may be formed between the deformable protrusions and the leading edge of the body, and the deformable protrusions may be deformed to a first shape by injecting a fluid into the spaces, and be deformed to a second space by discharging the fluid from the spaces.

Here, the deformable protrusions may be formed of a shape memory alloy.

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view of a rotary wing aircraft including conventional rotor blades;

FIG. 2 is a magnified view of one of the conventional rotor blades illustrated in FIG. 1;

FIG. 3 is a perspective view of a rotor blade for a rotary wing aircraft, according to an embodiment of the present invention;

FIG. 4 is a plan view when deformable protrusions protrude from the rotor blade illustrated in FIG. 3;

FIG. 5 is a plan view when a vortex collides with the deformable protrusions illustrated in FIG. 4;

FIG. 6 is a plan view when the deformable protrusions do not protrude from the rotor blade illustrated in FIG. 3;

FIG. 7 is a cross-sectional view of the rotor blade taken along a line VII-VII illustrated in FIG. 4; and

FIG. 8 is a cross-sectional view of the rotor blade taken along a line VIII-VIII illustrated in FIG. 6.

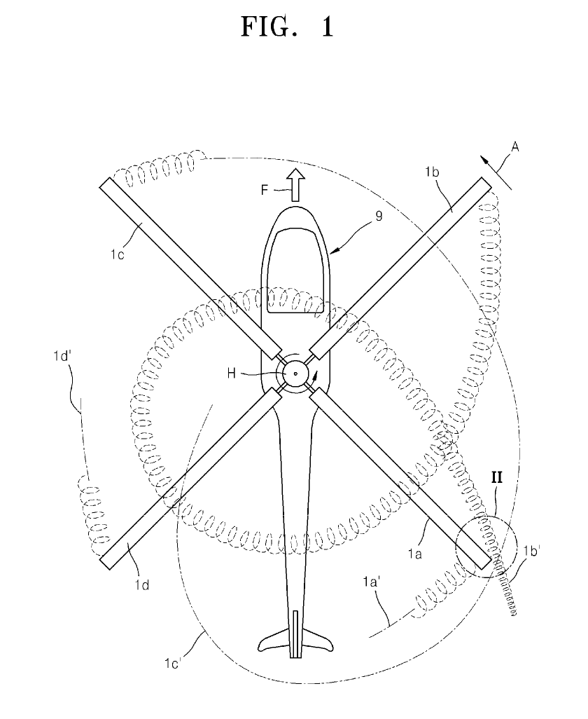

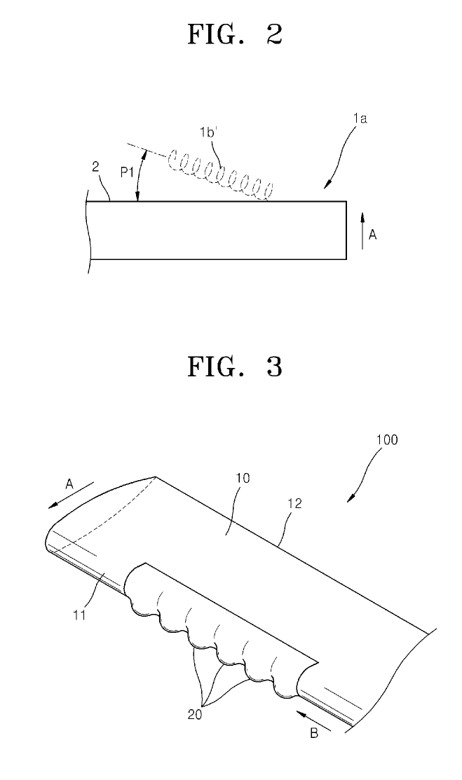

### DETAILED DESCRIPTION OF THE INVENTION

Hereinafter, the present invention will be described in detail by explaining embodiments of the invention with reference to the attached drawings.

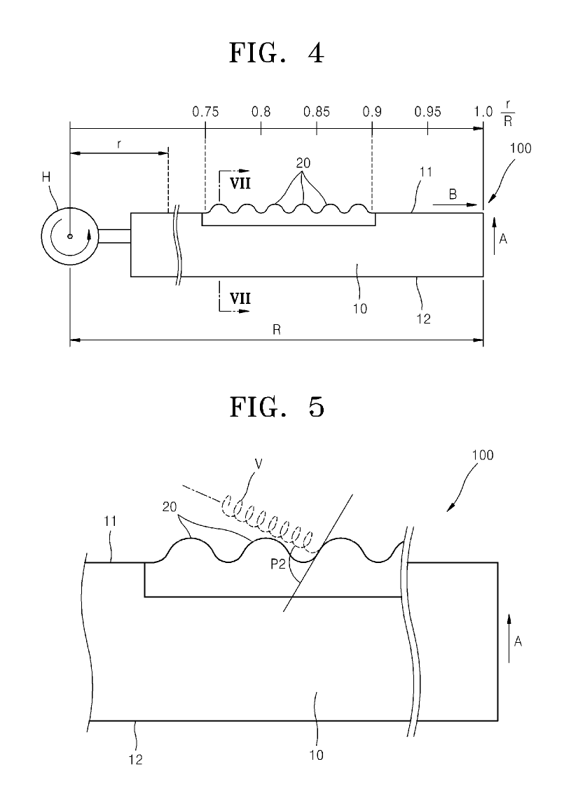

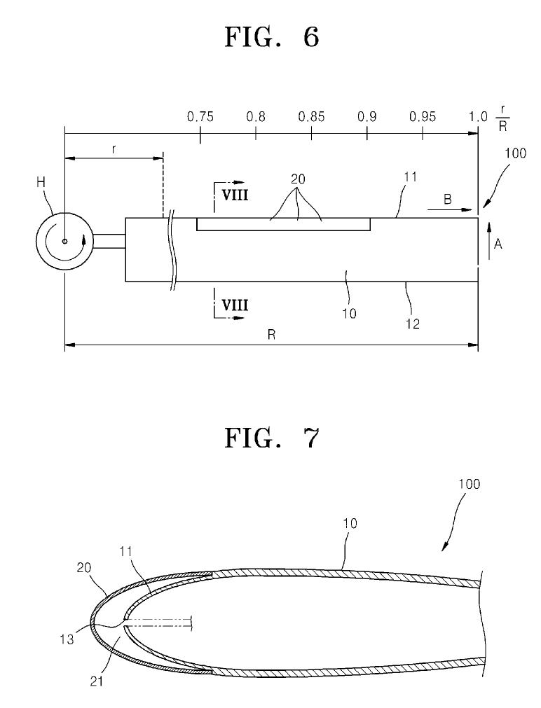

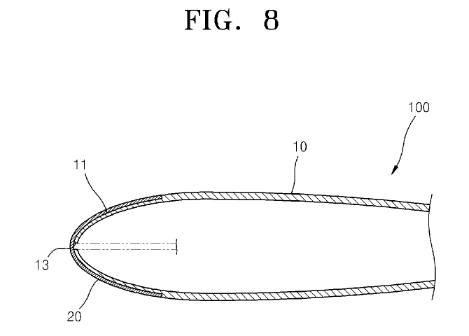

FIG. 3 is a perspective view of a rotor blade 100 for a rotary wing aircraft, according to an embodiment of the present invention. FIG. 4 is a plan view when deformable protrusions 20 protrude from the rotor blade 100 illustrated in FIG. 3. FIG. 5 is a plan view when a vortex collides with the deformable protrusions 20 illustrated in FIG. 4. FIG. 6 is a plan view when the deformable protrusions 20 do not protrude from the rotor blade 100 illustrated in FIG. 3. FIG. 7 is a cross-sectional view of the rotor blade 100 taken along a line VII-VII illustrated in FIG. 4. FIG. 8 is a cross-sectional view of the rotor blade 100 taken along a line VIII-VIII illustrated in FIG. 6.

Referring to FIGS. 3 through 6, the rotor blade 100 is a wing that rotates about and is combined with a rotation shaft H of the rotary wing aircraft, and includes a body 10 and the deformable protrusions 20.

As illustrated in FIG. 4, the body 10 is an airfoil wing having a rectangular shape that extends in a radial direction of rotation B and having a cross section perpendicular to the radial direction of rotation B and capable of generating lift.

The body 10 is combined with the rotation shaft H, and includes a leading edge 11 that is a front edge in a direction of rotation A and a trailing edge 12 that is a rear edge in the direction of rotation A.

A tip of the body 10 is at a location spaced apart from the rotation shaft H by the radius of rotation R, and an arbitrary location on the body 10 may be represented as a distance r from the rotation shaft H.

The deformable protrusions 20 are formed on the leading edge 11 of the body 10 in the radial direction of rotation B in a region from a point spaced apart from the rotation shaft H by 75% of the radius of rotation R (r/R=0.75) to a point spaced apart from the rotation shaft H by 90% of the radius of rotation R (r/R=0.9).

A space 21 that is sealable is formed between each of the deformable protrusions 20 and the leading edge 11 of the body 10. In the current embodiment, the space 21 is formed by pressing edges of the deformable protrusions 20 with a band-shaped member (not shown) and combining the band-shaped member on the leading edge 11 by using rivets (not shown).

A fluidic channel 13 connected to the space 21 is formed in the leading edge 11 of the body 10 so as to inject air into the space 21, and air may be injected into or discharged from the space 21 by using a pneumatic apparatus (not shown) connected to the fluidic channel 13.

In the current embodiment, the deformable protrusions 20 are formed of a complex material obtained by mixing synthetic rubber with high strength fibers in order to ensure sufficient deformation and to have excellent durability.

If air is injected into the spaces 21, the deformable protrusions 20 expand to have a first shape protruding forward in the direction of rotation A, as illustrated in FIG. 7. If air is discharged from the space 21, the deformable protrusions 20 contract to have a second shape not protruding forward in the direction of rotation A, as illustrated in FIG. 8.

Accordingly, the deformable protrusions 20 are deformable between the first shape and the second shape such that blade vortex interaction (BVI) noise generated when a vortex formed near a blade tip collides with the rotor blade 100 is selectively reduced whenever necessary.

Usage of the above-described rotor blade 100 will now be described.

When a rotary wing aircraft including the rotor blades 100 does not need to reduce BVI noise, for example, when the rotary wing aircraft hovers or flies horizontally forward, air is discharged from the spaces 21 such that the deformable protrusions 20 have the second shape not protruding forward in the direction of rotation A as illustrated in FIG. 6.

If the deformable protrusions 20 have the second shape contacting the leading edge 11 of the body 10, an aerodynamic advantage such as a reduction in drag may be achieved in comparison to a case when the deformable protrusions 20 have the first shape protruding forward in the direction of rotation A.

Also, when the rotary wing aircraft including the rotor blades 100 descends slowly to land at a residential area or a military area to penetrate into enemy territory, BVI noise needs to be reduced. Accordingly, in this case, air is injected into the spaces 21 such that the deformable protrusions 20 have the first shape protruding forward in the direction of rotation A, as illustrated in FIG. 4.

If the deformable protrusions 20 protrude forward in the direction of rotation A, aerodynamically, an aerodynamic disadvantage such as an increase in drag may be caused in comparison to a case when the deformable protrusions 20 have the second shape not protruding forward in the direction of rotation A. However, an angle P2 between a vortex V colliding with the rotor blade 100 and the leading edge 11 of the rotor blade 100 is close to 90° , as illustrated in FIG. 5, and thus BVI noise may be greatly reduced in comparison to the conventional rotor blade 1a.

As described above, since the rotor blade 100 may selectively protrude the deformable protrusions 20 forward in the direction of rotation A whenever a reduction in BVI noise is necessary, an aerodynamic feature such as drag may be preferentially considered when a rotary wing aircraft hovers or flies horizontally forward, and a reduction in BVI noise may be preferentially considered when the rotary wing aircraft descends slowly.

Also, the deformable protrusions 20 are formed in the region from the point spaced apart from the rotation shaft H by 75% of the radius of rotation R (r/R=0.75) to the point spaced apart from the rotation shaft H by 90% of the radius of rotation R (r/R=0.9) because BVI noise is mostly generated between the above region (0.75<r/R<0.9).

If the deformable protrusions 20 are formed in the region (0.75 <r/R<0.9), in comparison to a case when the deformable protrusions 20 are formed on the entire leading edge 11 of the body 10, an overall manufacturing cost of the rotor blade 100 may be reduced and an overall operating cost of the rotor blade 100 may also be reduced, for example, energy used to deform the deformable protrusions 20 may be reduced.

Although the pneumatic apparatus for injecting or discharging air into or from the spaces 21 to deform the deformable protrusions 20 is used in the current embodiment, alternatively, the deformable protrusions 20 may be formed of a shape memory alloy so as to be deformed between the first shape and the second shape without using the spaces 21 and the pneumatic apparatus.

According to the present invention, by forming a plurality of deformable protrusions that variably protrude or do not protrude from a leading edge, BVI noise may be selectively reduced whenever necessary. Also, by forming the deformable protrusions in a region between a point spaced apart from a rotation shaft by 75% of the radius of rotation and a point spaced apart from the rotation shaft H by 90% of the radius of rotation, manufacturing and operating costs of a rotor blade may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A rotor blade for a rotary wing aircraft, which rotates about and is combined with a rotation shaft of the rotary wing aircraft, the rotor blade comprising:
a body combined with the rotation shaft and comprising a leading edge that is a front edge in a direction of rotation; and
a plurality of deformable protrusions formed on the leading edge of the body in a radial direction of rotation, and deformable between a first shape protruding forward in the direction of rotation and a second shape not protruding forward in the direction of rotation such that BVI noise generated when a vortex formed near a blade tip collides with the rotor blade is selectively reduced whenever necessary,
wherein the deformable protrusions are formed in a region from a point spaced apart from the rotation shaft by 75% of a radius of rotation to a point spaced apart from the rotation shaft by 90% of the radius of rotation.

2. The rotor blade of claim 1, wherein spaces that are sealable are formed between the deformable protrusions and the leading edge of the body, and
wherein the deformable protrusions are deformed to a first shape by injecting a fluid into the spaces, and are deformed to a second space by discharging the fluid from the spaces.

3. The rotor blade of claim 1, wherein the deformable protrusions are formed of a shape memory alloy.
